(19) United States
(12) Patent Application Publication
(10) Pub. No.: US 2012/0062368 A1
(43) Pub. Date: Mar. 15, 2012

(54) Hospital Identification Bracelet

(75) Inventors: Eduardo Graells Ferrandez, Barcelona (ES); Francesc Ribas-Ariño, Girona (ES)

(73) Assignee: VERIDENTIA, S.L., Ripollet, Barcelona (ES)

(21) Appl. No.: 13/321,918

(22) PCT Filed: Oct. 6, 2009
(86) PCT No.: PCT/ES2009/000484

§ 371 Date: Nov. 22, 2011

(30) Foreign Application Priority Data
May 29, 2009 (ES) U200930150

(51) Int. Cl. H04Q 5/22

(52) U.S. Cl. 340/10.1

(57) ABSTRACT

A hospital identification bracelet includes a flexible strip (1) with several self-adhesive labels (2) for receiving printed or printable bar codes, a writable area (5) for patient data and the label codes, together with a simple closing device, and a RFID transponder (6) of Identification by Radio Frequency, fixed to the flexible strip (1) and on which the corresponding code is printed with the self-adhesive label codes (2) in a biunivocal manner. The flexible strip (1) presents perforation lines (3) for the independent separation of the self-adhesive labels (2) with the printed or printable codes.

### PURPOSE OF THE INVENTION

This invention refers to a bracelet for hospital identification that is applicable to unique patient identification, of samples taken for analysis, drugs and clinical files and case histories that relate to the patient.

### BACKGROUND OF THE INVENTION

In hospitals and health centers, where supplies are made of hemocomponents and drugs for patient treatments, it is very important to ensure that these hemocomponents or drugs are supplied to the correct patient. Control of such processes is always delicate, but this is especially so when the center is so big that there are normally a large number of patients in these circumstances.

These operations mainly consist of identifying the patient, extract blood samples for analysis and determine which hemocomponents or transfusions are necessary. In the case of drugs, sample extraction is not required. The necessary hemocomponents are subsequently selected from the blood bank, which are then sent to the hospital staff who are responsible for the patient so that they can perform the transfusion. The process is the same for drugs. It is possible in such operations to carry out traceability or tracking so that recording of the actions and any incidents must be carried out.

Unique or biunivocal identification of the patient, the samples for analysis, and of the hemocomponents or drugs to be supplied to the patient is the base for various control systems that are designed to prevent errors and confusions.

For example, one employed system is the use of patient identification at the head of the bed, which is annotated on the sample containers that are sent to the blood bank. After performing the corresponding analyses, the blood bank sends the hemocomponents to the requesting personnel or the requested drugs from the pharmacy, together with a tracking code for said hemocomponents. The health staff receiving the hemocomponents or drugs are usually responsible for several patients and distribute them in accordance with the supplied codes and fill out a report if there are any incidents or problems. These codes are normally handwritten which involves the possibility of the personnel intervening in the successive steps misreading the codes or accidently changing the packages employed, with subsequent risk to the patient.

One alternative is to make use of a bracelet with several adhesive labels for printed codes, a writable area for the patient's name and the label codes, together with a simple closing mechanism. The bracelet is worn on the patient's wrist and the sample containers are identified with the adhesive labels. However, there is the problem of hemocomponents or drug reception because the staff who are going to administer the product must visually read the numeric code with the accompanying possibility of a mistake in reading such abstract data.

There are other systems based on the use of handheld computers by the health staff involved in all the steps for supplying the hemocomponents or drugs so that patient identification is not made on the sample, but within the computer network. This system is much safer and objective, but does mean higher costs and more complex handling because the health staff are obliged to learn more or less complex computer applications. Moreover, in services such as emergencies or operating theaters, agility and simplicity of use are essential and so, systems that are complicated to use by the associated health staff cannot be employed.

### DISCLOSURE OF THE INVENTION

The hospital identification bracelet of this invention presents certain technical peculiarities that are intended to optimize hospital operation and, above all, the supply of hemocomponents and drugs, with complete safety and objectivity, maintaining high simplicity of use by health staff, with the possibility of total traceability and maintaining a record of the operation.

According to the invention, in addition to the number of adhesive labels for printing the codes, the writable area and the simple closing mechanism, the flexible strip also essentially includes an RFID transponder with recorded data corresponding to the adhesive label codes in a biunivocal manner.

Moreover, the flexible strip presents die-cuts for the independent separation of the adhesive labels with the printed or printable codes.

This configuration provides considerable advantages because, once the patient is wearing the bracelet, the adhesive labels allow rapid, direct sample identification without any handwritten codes, and in addition, the RFID transponder provides correct patient computerised identification using a suitable reader, for example, by the clinical records control computers, in radiography machines and other treatment devices. This RFID transponder system can even be employed to track and trace hemocomponent and drug delivery using the packaging and sealed items incorporating RFID readers programmed with the RFID transponder code.

In this way, identification is unique at all times and there are no problems with code exchange mistakes. Moreover, there is the final safety of the hemocomponents or drugs not being opened unless in front of the bracelet initially worn by the patient and blocking access at all times against accidental opening, for example, in front of another patient. This is a simple identification method that does not require medical staff to employ complex computer equipment as its use is completely transparent.

The printed or printable bar codes that facilitate automatic identification reading can be made in a second mode, by low-cost optical reading, while still maintaining both functionality and safety. The labels with the printed bar codes are ideal for identifying multiple blood samples that are sent to a laboratory, still maintaining computerised traceability, which is much safer than handwritten codes. These bar codes can be printed when the bracelet is issued to be worn by the patient or can be supplied pre-printed when manufactured.

The simple closing mechanism of the flexible strip comprises a self-adhesive area covered by a disposable protective sheet and an intermediate area of said flexible strip has die-cuts to show manipulation of said bracelet by tearing, once fitted. The self-adhesive area permits rapid, direct fitting, with adjustment to the patient's wrist by sampling folding the strip forming the bracelet and sticking the adhesive area to the opposite end, producing the tearing of the die-cuts. Moreover, these die-cuts prevent cases of incorrect exchange or manipulation.

### DESCRIPTION OF THE FIGURES

To complement this description and to facilitate understanding of the characteristics of the invention, this descriptive report is accompanied by a set of drawings, having merely an illustrative, non-limiting character in which the following is represented:

FIG. 1 is a front view of the extended bracelet.

FIG. 2 shows a reverse view of the extended bracelet.

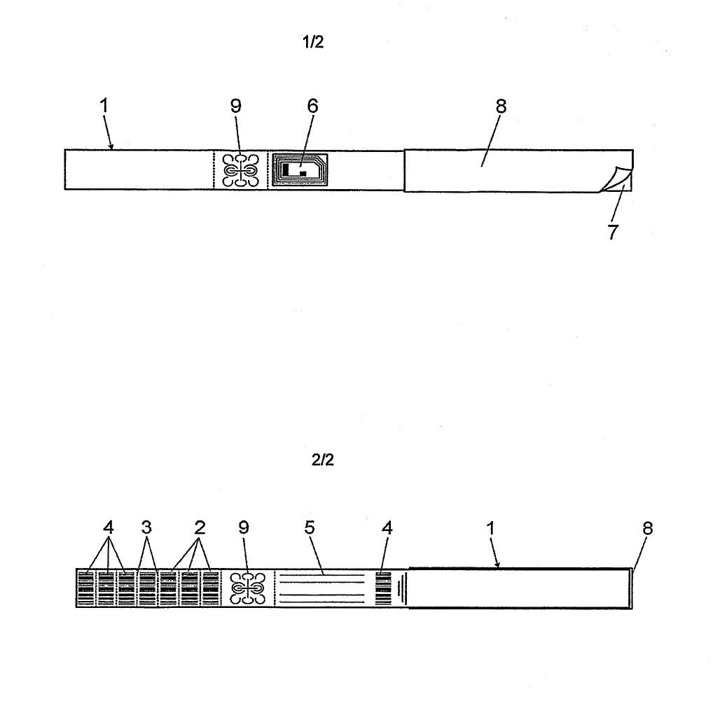

### EXEMPLARY EMBODIMENT OF THE INVENTION

As can be seen in the referenced figures, the bracelet comprises a thin, strong flexible strip (1) with several self-adhesive labels (2) separated by lines of perforation (3), with printed or printable bar codes (4) on the self-adhesive labels (2), a writable area (5) for patient data and the bar code (4) on the self-adhesive labels (2) and an RFID transponder (6).

The bracelet comprises a simple closing mechanism, configured, in this case by a self-adhesive area (7) that is covered by a disposable protective sheet (8) that is removed when used and, in an intermediate area of the flexible strip (1), die cuts (9) to reveal improper manipulation of the bracelet by tearing when the self-adhesive (7) area is stuck over said die-cuts (9) by bending the flexible strip (1) into a “U” shape.

Once the nature of the invention is sufficiently described, together with an exemplary embodiment, it is placed on the record for whatever purpose that the materials, shape, size and arrangement of the described elements may be modified, provided this does not involve any alteration to the essential characteristics of the invention that are claimed below.

What is claimed is:

1-3. (canceled)

4. A hospital identification bracelet comprising:
a flexible strip including:
several self-adhesive labels for receiving at least one of printed and printable bar codes,
perforation lines for independent separation of the self-adhesive labels with the at least one of printed and printable bar codes,
a writable area for patient data and label codes, and
a closing mechanism for closing the strip about a wrist of a person, the closing mechanism including a self-adhesive area on which there is a protective lamina that is removed when used, and
an intermediate area including pre-cuts that become broken to show handling of said bracelet once said bracelet is fitted to a person's wrist; and
an RFID transponder which provides identification by radio frequency signals, fixed to the flexible strip and on which a corresponding code is printed with the self-adhesive label codes in a biunivocal manner.
